(19) United States
(12) Patent Application Publication
(10) Pub. No.: US 2026/0081827 A1
(43) Pub. Date: Mar. 19, 2026

(54) METHOD FOR SYNCHRONIZING CONFIGURATION INFORMATION IN MICROSERVICE PLATFORM WITHIN CLOUD COMPUTING ENVIRONMENT AND SYSTEM IMPLEMENTING THEREOF

(71) Applicant: dongobi soft, Seoul (KR)

(72) Inventors: Daesoo Ahn, Gyeonggi-do (KR); Yongsoo Hur, Seoul (KR)

(21) Appl. No.: 18/895,517

(22) Filed: Sep. 25, 2024

(30) Foreign Application Priority Data
Sep. 19, 2024 (KR) 10-2024-0126819

(51) Int. Cl. H04L 41/0813; H04L 41/0859

(52) U.S. Cl. CPC H04L 41/0813; H04L 41/0859

(57) ABSTRACT

Disclosed is a technique of synchronizing configuration information in a microservice platform. A system for synchronizing configuration information in a microservice platform of the present disclosure includes a configuration information server which creates a configuration information list when configuration information is changed to transmit the configuration information list to a configuration information client and a microservice module which is an object to which the changed configuration information is applied in a microservice platform and includes the configuration information client and a configuration information processor, and if configuration information set in the configuration information processor is included in the configuration information list, the configuration information client acquires the changed configuration information from the configuration information server to transmit the changed configuration information to the configuration information processor.

### BACKGROUND

### Field

The present disclosure relates to a technique of synchronizing configuration information in a microservice platform, and more particularly, to a method for synchronizing configuration information in a microservice platform within a cloud computing environment and a system implementing the same.

### Description of the Related Art

The cloud computing is a service which provides computing resources, such as a server, a storage, a database, networking, and software, through the Internet. In the cloud computing environment, if necessary, a user may add or remove a computing resource or use a management infrastructure provided by the cloud to flexibly and efficiently utilize the computing resources.

Microservices are an architectural style which divides one big application into independent service units to develop, extend, deploy, and operate the service units. Each microservice performs a specific business function and is developed, extended, deployed, and operated independently from the other service to increase a development speed for every service and flexibly provide the services. A container is a virtualization technology which packages everything required to execute an application into one and is executed while being isolated from a host operating system, which allows various applications to be simultaneously executed on the same hardware.

The cloud computing environment may provide the flexibility and scalability required to implement the microservice architecture. Further, the cloud computing environment makes it easy to manage and deploy the microservice through an automated management tool and a continuous integration (CI)/continuous deployment (CD) pipeline.

In the meantime, when it is necessary to change the configuration information of the microservice in the microservice platform, generally, the configuration information of the microservice is changed and the microservice with the changed configuration information is deployed. When the microservice is deployed after changing the configuration information, the configuration information needs to be accurately changed for all logical configuration ranges in which the microservices are installed. If the change of the configuration information is not reflected due to some errors, each microservice performs the microservice using substantially different configuration information, which may cause unexpected microservice errors.

Accordingly, there is a necessity to develop a technology which stably provides the microservice when the configuration information is changed in the microservice platform.

### Related Art Document

### Patent Document

Patent Document 1: Korean Unexamined Patent Application Publication No. 10-2022-0064653 (May 19, 2022)

### SUMMARY

The present disclosure is provided to overcome the problems of the related art as described above and a technical object to be achieved by the present disclosure is to provide a configuration information synchronizing method in a microservice platform and a synchronizing system which synchronize configuration information in real time by transmitting a notification of the change in the configuration information to each microservice when the configuration information is changed in the microservice platform.

Another technical object to be achieved by the present disclosure is to provide a configuration information synchronizing method in a microservice platform and a synchronizing system which request notification of change in the configuration information by comparing configuration information versions when there is no notification of change in the configuration information for a predetermined period of time.

Technical objects of the present disclosure are not limited to the aforementioned technical objects and other technical objects which are not mentioned above will be apparently appreciated by those skilled in the art from the following description.

In order to achieve the above-described technical object, according to an aspect of the present disclosure, a system for synchronizing configuration information in a microservice platform includes a configuration information server which creates a configuration information list when configuration information is changed to transmit the configuration information list to a configuration information client; and a microservice module which is an object to which the changed configuration information is applied in a microservice platform and includes the configuration information client and a configuration information processor, and if configuration information set in the configuration information processor is included in the configuration information list, the configuration information client acquires the changed configuration information from the configuration information server to transmit the changed configuration information to the configuration information processor.

In one exemplary embodiment, the microservice module is a microservice application which performs a specific function in a microservice platform.

In one exemplary embodiment, the configuration information includes a configuration information item and a configuration information content and the configuration information list includes the configuration information item.

In one exemplary embodiment, the configuration information includes file information, attribute information, and version information used to run, perform, and end a microservice.

In one exemplary embodiment, the file information includes a setting file required to operate the microservice and a certificate file and the attribute information includes a key-value type setting information.

In one exemplary embodiment, the version information includes at least one of a version number which identifies a version state of the configuration information and a timestamp.

In one exemplary embodiment, the configuration information includes a plurality of configuration information and the configuration information processor includes a plurality of configuration information processors which processes each of the plurality of configuration information.

In one exemplary embodiment, the configuration information processor changes the configuration information setting according to the changed configuration information which is received from the configuration information client to adjust an operation of the microservice.

In one exemplary embodiment, the configuration information server transmits the configuration information list to the configuration information client in a real time transfer method selected from HTTP polling, HTTP long polling, Websocket, Server-sent events, and rRPC.

In one exemplary embodiment, the configuration information server and the configuration information client hold version information of the configuration information and the configuration information client compares version information of current configuration information of the configuration information client with version information of current configuration information of the configuration information server and if the version information do not match, requests the configuration information list from the configuration information server.

In one exemplary embodiment, if the configuration information list is not received from the configuration information server for a predetermined period of time, the configuration information client requests the version information of the current configuration information of the configuration information server from the configuration information server and compares the current configuration information of the configuration information server received from the configuration information sever with version information of the current configuration information of the configuration information client.

In order to achieve the technical object, according to an aspect of the present disclosure, a method for synchronizing configuration information in a microservice platform includes a configuration information change notifying step of receiving changed configuration information to create a configuration information list and transmit the created configuration information list to a configuration information client, by a configuration information server; a configuration information list checking step of reviewing the configuration information list to check whether configuration information set in a configuration information processor is included in the configuration information list, by the configuration information client; and a changed configuration information applying step of acquiring the changed configuration information from the configuration information server, if configuration information set in a configuration information processor is included in the configuration information list, to change the changed configuration information to be set in the configuration information processor, by the configuration information client.

In one exemplary embodiment, the configuration information change notifying step includes: a changed configuration information receiving step of receiving configuration information changed by a configuration information manager, by the configuration information server; and a configuration information list transmitting step of creating a configuration information list using the received configuration information and transmitting the configuration information list to the configuration information client to notify the change of the configuration information, by the configuration information server.

In one exemplary embodiment, the configuration information includes a configuration information item and a configuration information content and the configuration information list includes at least one of configuration information categories.

In one exemplary embodiment, the configuration information list checking step includes: a configuration information list receiving step of receiving the configuration information list from the configuration information server, by the configuration information client; and a configuration information list reviewing step of reviewing the configuration information list and checking whether the configuration information item set in a configuration information processor is included in the configuration information list.

In one exemplary embodiment, the changed configuration information applying step includes: a configuration information acquiring step of requesting configuration information about an item set in the configuration information processor from the configuration information server if the configuration information set in the configuration information processor is included in the configuration information list, to acquire changed configuration information, by the configuration information client; and a changed configuration information reflecting step of dynamically adjusting an operation of a microservice according to the changed and set configuration information by changing and setting the configuration information according to the acquired changed configuration information, by the configuration information processor.

In one exemplary embodiment, the configuration information server manages configuration information including a configuration information version, a configuration information item, and a configuration information content and the configuration information client holds a latest configuration information version.

In one exemplary embodiment, the configuration information change notifying step includes: a changed configuration information receiving step of receiving configuration information changed by a configuration information manager, by the configuration information server; and a configuration information version checking step of requesting the configuration information version from the configuration information server to compare with a configuration information version of the configuration information client and requesting the configuration information list from the configuration information server if version information of the configuration information server does not match version information of the configuration information client, by the configuration information client; and a configuration information list transmitting step of creating a configuration information list using the received configuration information and transmitting the configuration information list to the configuration information client, by the configuration information server.

In the exemplary embodiment, the configuration information list is a configuration information list including a changed content between version information of the configuration information server and version information of the configuration information client.

In one exemplary embodiment, the configuration information version checking step includes: a step of requesting a version of configuration information from the configuration information sever when there is no notification of change of the configuration information of the configuration information server for a predetermined period of time or periodically.

According to one exemplary embodiment, The predetermined period of time is a period of time for considering that the configuration information list has failed to be received to retry the reception when the configuration information client does not receive the configuration information list from the configuration information server.

In one exemplary embodiment, the configuration information includes file information and attribute information used to run, perform, and end a microservice.

In one exemplary embodiment, the configuration information includes file information, attribute information, and version information used to run, perform, and end a microservice.

In one exemplary embodiment, the file information includes a setting file required to operate the microservice and a certificate file and the attribute information includes a key-value type setting information.

According to the present disclosure, a configuration information synchronizing method in a microservice platform and a synchronizing system which synchronize configuration information in real time by transmitting a notification of the change in the configuration information to each microservice when the configuration information is changed in the microservice platform are provided.

According to the present disclosure, a configuration information synchronizing method in a microservice platform and a synchronizing system which request notification of change in the configuration information by comparing configuration information versions when there is no notification of change in the configuration information for a predetermined period of time are provided.

In addition, various effects which are directly or indirectly identified through the present specification may be provided.

### BRIEF DESCRIPTION OF THE DRAWINGS

FIG. 1 is an overall system diagram which implements a configuration information synchronization technique in a microservice platform according to an exemplary embodiment of the present disclosure;

FIG. 2 is a view illustrating creation of a configuration information list of a configuration information server according to an exemplary embodiment of the present disclosure;

FIG. 3 is a view illustrating confirmation of a configuration information list of a configuration information client according to an exemplary embodiment of the present disclosure;

FIG. 4 is a view illustrating acquisition of changed configuration information of a configuration information client according to an exemplary embodiment of the present disclosure;

FIG. 5 is a procedure flowchart for explaining a method for synchronizing configuration information in a microservice platform according to an exemplary embodiment of the present disclosure;

FIG. 6 is a procedure flowchart for explaining a configuration information change notifying step of FIG. 5 in detail;

FIG. 7 is a procedure flowchart for explaining a configuration information list checking step of FIG. 5 in detail;

FIG. 8 is a procedure flowchart for explaining a changed configuration information applying step of FIG. 5 in detail;

FIG. 9 is a procedure flowchart for explaining a method for synchronizing configuration information in a microservice platform according to another exemplary embodiment of the present disclosure; and

FIG. 10 is an exemplary diagram for explaining the necessity to notify changed configuration information when configuration information is changed in a microservice platform to another microservice, by a configuration information server according to an exemplary embodiment of the present disclosure.

### DETAILED DESCRIPTION OF THE EMBODIMENT

Hereinafter, the present disclosure will be described in more detail with reference to the drawings. In the drawings, it should be noted that the same elements will be denoted by the same reference numerals wherever possible. Further, the detailed description of a known function and configuration that may make the gist of the present invention unnecessarily ambiguous will be omitted.

Terms used in the present disclosure are used only to describe specific exemplary embodiments, and are not intended to limit the present invention. A singular form may include a plural form if there is no clearly opposite meaning in the context. In the present disclosure, it should be understood that term “include (includes, including)” or “have (has, having)” indicates that a feature, a number, a step, an operation, a component, a part or the combination thereof described in the specification is present, but do not exclude a possibility of presence or addition of one or more other features, numbers, steps, operations, components, parts or combinations, in advance.

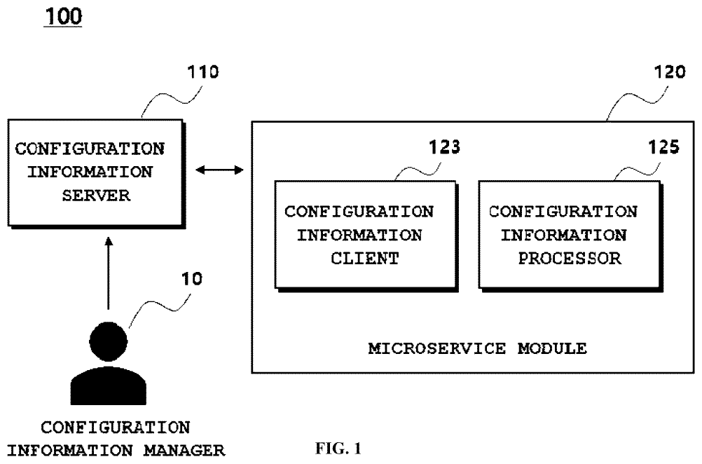

FIG. 1 is an overall system diagram which synchronizes configuration information in a microservice platform according to an exemplary embodiment of the present disclosure.

Referring to FIG. 1, an overall system 100 for synchronizing configuration information in a microservice platform according to the exemplary embodiment of the present disclosure includes a configuration information server 110 and a microservice module 120.

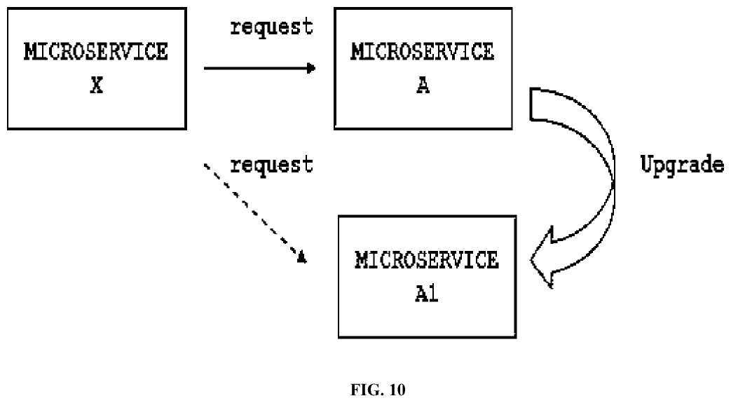

The configuration information server 110 may be a centralized configuration information provider server. The configuration information server 110 manages configuration information used for the microservice platform and when the configuration information is changed by a configuration information manager 10, notifies another microservice of the changed configuration information. The case when the configuration information is changed includes microservice upgrade, microservice configuration change, database setting change, API end point change, security authentication information change, log-in setting change. For example, a microservice X transmits a first request to a microservice A and the microservice A is upgraded to become a microservice A1 so that configuration information of the microservice X is changed. As described above, when the configuration information of the microservice X is changed, the configuration information server 110 provides the changed configuration information to the microservice X to notify that a microservice to which the request is to be transmitted is the microservice A1 (see FIG. 10).

Here, the configuration information may be information used to run, perform, and end the microservice. The configuration information includes file information, attribute information, and version information.

The file information includes a configuration file required to operate the microservice and a certificate file. The configuration file may be a file which defines an operation method of the microservice. For example, the configuration file may be a file including database access information to be used by the microservice and API end point information for communication with an external service or between the microservices. The certificate file includes a certificate and a key file used for security and encryption. The certificate includes a SSL/TLS certificate.

The attribute information may be key-value type configuration information. For example, the attribute information may be used to set the database connection or set a microservice log level.

The version information may be information indicating a version state of the configuration information. The version information is updated when the configuration information is changed or updated and includes a version number or a timestamp for each configuration information. The version number may be a numbers or a string which identifies a specific version of the configuration information and the timestamp includes the date and time recording a timing when the configuration information was last changed. The version information may be used as a criterion for the configuration information server 110 to determine whether the configuration information is changed. To be more specific, the configuration information server 110 receives the configuration information changed by the configuration information manager 10 to create a configuration information list and transmits the created configuration information list to the configuration information client 123 to notify the microservice module 120 of the change of the configuration information. The configuration information server 10 provides the changed configuration information to the configuration information client 120 in response to the request of the configuration information client 123. The changed configuration information may be configuration information matching configuration information set to the configuration information processor 125, among configuration information included in the configuration information list.

The configuration information server 110 transmits the configuration information list to the configuration information client 123 by a real-time transmission method. For example, the configuration information server 110 transmits the configuration information list to the configuration information client 123 by a real-time transfer method, such as HTTP Polling, HTTP long polling, WebSocket, Server-sent events, or rRPC.

The configuration information server 110 is implemented by being actually deployed to one physical server or virtual server. The configuration information server includes a database or a file system which stores configuration information and also includes a network interface for communication with the configuration information client 123.

The microservice module 120 may be an individual microservice application which performs a specific function in the microservice platform. The microservice module 120 may be an object to which changed configuration information is applied in the microservice platform. For example, the microservice module 120 applies the changed configuration information which is provided by the configuration information 110 to perform a specific function corresponding to the microservice. To this end, the microservice module 120 may be configured to include the configuration information client 123 and at least one configuration information processor 125.

The configuration information client 123 is a client of the configuration information server 110 and receives the changed configuration information from the configuration information server 110 and transmits the changed configuration information to the configuration information processor 125. To be more specific, when the configuration information client 123 receives the configuration information list notifying the change of the configuration information from the configuration information server 110, the configuration information client 123 reviews the configuration information list and checks whether configuration information set in the configuration information processor 125 is included in the configuration information list. If the configuration information set in the configuration information processor 125 is included in the configuration information list, the configuration information client 123 acquires the changed configuration information from the configuration information server 110 to transmit the changed configuration information to the configuration information processor 125.

The configuration information client 123 may automatically receive the configuration information list from the configuration information server 110 and also receive the configuration information from the configuration information server 110 upon the request of the configuration information client 123 to transmit the configuration information to the configuration information processor 125. For example, the configuration information client 123 has current version information which is finally received by the configuration information client 123 and if there is no notification of change of the configuration information of the configuration information server 110 for a predetermined period of time or periodically, requests and receives the latest version information from the configuration information server 110. If the latest version information of the configuration information server 110 does not match the current version information of the configuration information client 123, the configuration information client 123 determines that the notification of the change of the configuration information has failed to be received and requests and receives the configuration information list from the configuration information server 110.

Here, the predetermined period of time may be a period of time for considering that the configuration information list has failed to be received to retry the reception when the configuration information client 123 does not receive the configuration information list from the configuration information server 110. The predetermined period of time may vary depending on system requirements and network conditions and may be experimentally set to an optimal period of time according to the system requirements and the network conditions.

The configuration information list may be a configuration information list including changed matters between the latest version information and the current version information. If the configuration information set in the configuration information processor 125 is included in the received configuration information list, the configuration information client 123 acquires the changed configuration information from the configuration information server 110 to transmit the changed configuration information to the configuration information processor 125.

The configuration information client 123 may be present as a library or a module included in the microservice. The configuration information client 123 may be present in a container or a server in which the microservice is disposed. The configuration information client 123 includes a memory or a local file system for storing configuration information and a network interface for communicating with the configuration information server 110.

The configuration information processor 125 adjusts the operation of the microservice according to the configuration information received from the configuration information client 123. For example, the configuration information processor 125 changes and sets the configuration information according to the changed configuration information which is provided from the configuration information client 123 and dynamically changes the setting or the operation of the microservice according to the changed and set configuration information.

The configuration information processor 125 is present in the microservice process, like the configuration information client 123, and is implemented as a software module. The configuration information processor 125 includes a local storage device, such as a memory or a disk, which stores the configuration information and required data of the configuration information processor 125.

The configuration information processor 125 includes a plurality of configuration information processors which individually processes the plurality of configuration information. For example, the changed configuration information is change of database connection information and external API end point and the configuration information processor includes two configuration information processors which process respective configuration information corresponding to respective changed configuration information, that is, a first configuration processor and a second configuration processor.

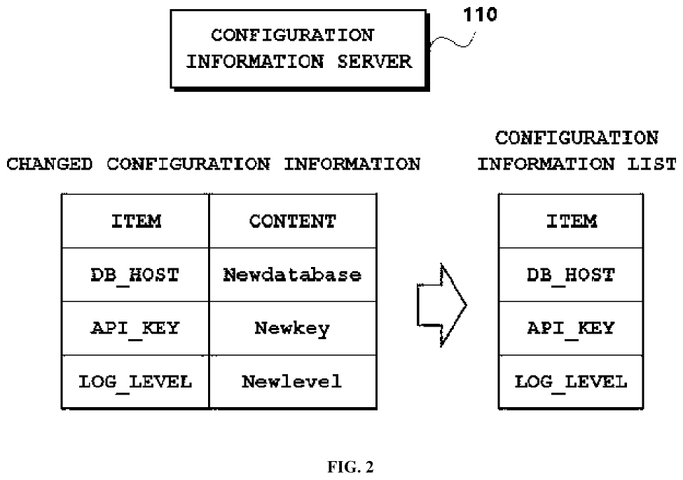

FIG. 2 is a view illustrating creation of a configuration information list of a configuration information server according to an exemplary embodiment of the present disclosure.

Referring to FIG. 2, the configuration information according to the exemplary embodiment of the present disclosure is configured to include configuration information items and configuration information contents. The configuration information list is configured to include at least one configuration information item.

The configuration information server 110 may receive configuration information changed by the conformation information manager 10. For example, the configuration information changed by the configuration information manager 10 may include database connection information, an API key, and a log level. An item of changed new database connection information may be “DB_HOST” and a content may be “Newdatabase”. An item of a changed new API Key may be “API_KEY” and a content may be “Newkey”. An item of the changed new log level may be “LOG_LEVEL” and a content may be “Newlevel”.

The configuration information server 110 may extract a configuration information item from the changed configuration information to create a configuration information list. For example, the configuration information server 110 may create a configuration information list including the item of the database connection information, “DB_HOST”, the item of the API Key, “API_KEY”, and the item of the log level, “LOG_LEVEL”, from the changed configuration information.

Through the above-described process, the configuration information server 110 receives the configuration information changed by the configuration information manager 10 to create a configuration information list and transmits the created configuration information list to the configuration information client 123 to notify the microservice module 120 of the change of the configuration information.

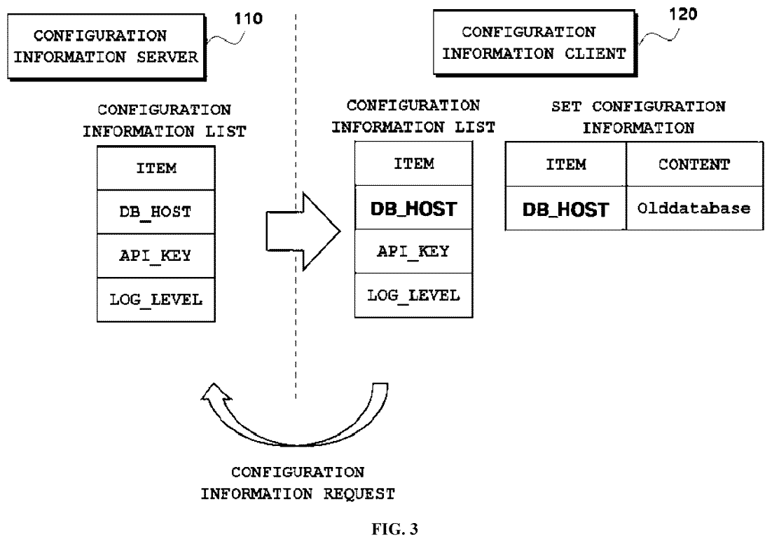

FIG. 3 is a view illustrating confirmation of a configuration information list of a configuration information client according to an exemplary embodiment of the present disclosure. Referring to FIG. 3, the configuration information server 110 may provide the configuration information list created in FIG. 2 to the configuration information client 120. For example, the configuration information server 110 may provide a configuration information list including the item of the database connection information, “DB_HOST”, the item of the API Key, “API_KEY”, and the item of the log level, “LOG_LEVEL”, to the configuration information client 120.

The configuration information client 123 checks whether configuration information set in the configuration information processor is included in the received configuration information list. To be more specific, the configuration information client 123 reviews the received configuration information list and checks whether the configuration information item set in the configuration information processor is included in the received configuration information list. For example, the configuration information client 123 checks whether the configuration information item “DB_HOST” set in the configuration information processor is included in the configuration information list.

Through the above-described process, the configuration information server 110 provides the configuration information list to the configuration information client 120 and the configuration information client 123 checks whether the configuration information item set in the configuration information processor is included in the received configuration information list. If the configuration information set in the configuration information processor is included in the received configuration information list, the configuration information client 120 requests the configuration information about an item set in the configuration information processor from the configuration information server 110. In the present exemplary embodiment, the configuration information about the item set in the configuration information processor includes database connection information, that is, the item of the database connection information, “DB_HOST”, and the content of the changed database connection information.

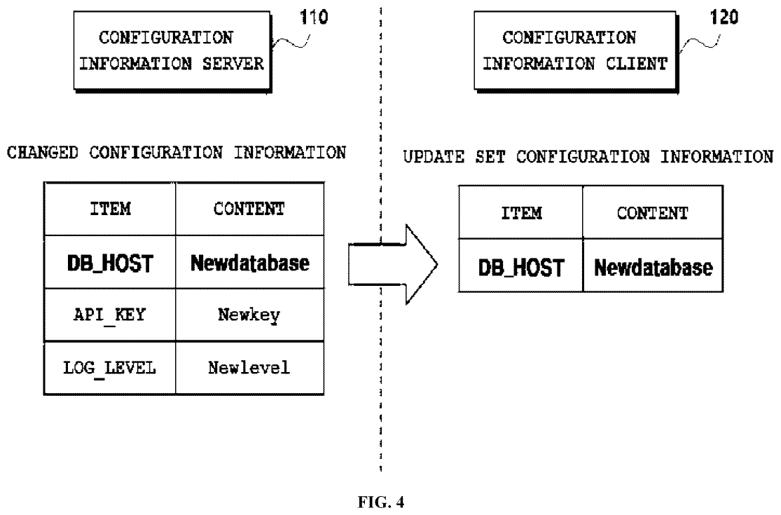

FIG. 4 is a view illustrating acquisition of changed configuration information of a configuration information client according to an exemplary embodiment of the present disclosure. Referring to FIG. 4, the configuration information server 110 provides the changed configuration information to the configuration information client 123 upon the request of the configuration information of the configuration information client 123 of FIG. 3. For example, the configuration information server 110 provides the changed configuration information requested by the configuration information client 123 in FIG. 3, that is, configuration information including the content of the changed database connection information, “Newdatabase”, among the changed configuration information, to the configuration information client 123.

If the configuration information client 123 transmits the changed configuration information which is provided from the configuration information server 110 to the configuration information processor 125, the configuration information processor 125 changes and sets the previous configuration information to the received configuration information. For example, the configuration information processor 125 changes a content of the previous database connection information “Olddatabase” to a content of the changed database connection information “Newdatabase” to set the configuration information.

Through the above-described process, when the configuration information is changed, the configuration information processor 123 changes the setting with the configuration information and the microservice tries to be connected to a new database host according to the changed database connection information.

It has been described with reference to FIGS. 2 to 4 that when a database host address is changed by the configuration information manager or a system, the configuration information server creates a configuration information list based on the changed items to transmit the configuration information list to the configuration information client and the configuration information client transmits the changed configuration information obtained by reviewing the configuration information list to the configuration information processor, and the configuration information processor updates the database connection setting of the microservice with the changed configuration information. However, the present disclosure is not limited thereto, but may be applied in the same or similar manner even when the other configuration information is changed.

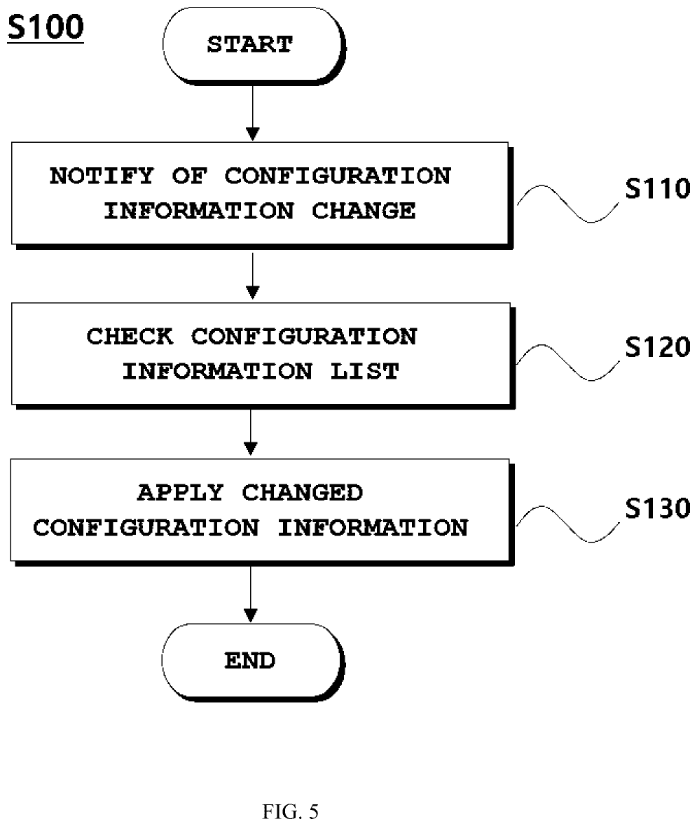

FIG. 5 is a procedure flowchart for explaining a method for synchronizing configuration information in a microservice platform according to an exemplary embodiment of the present disclosure.

Referring to FIG. 5, a method S100 for synchronizing configuration information in a microservice platform according to an exemplary embodiment of the present disclosure is configured to include a configuration information change notifying step S110, a configuration information list checking step S120, and a changed configuration information applying step S130.

In the configuration information change notifying step S110, the configuration information server 110 receives changed configuration information to create a configuration information list and transmits the created configuration information list to the configuration information client 123 to notify the change of the configuration information.

In the configuration information list checking step S120, the configuration information client 123 reviews the configuration information list to check whether the configuration information set in the configuration information processor is included in the configuration information list.

In the changed configuration information applying step S130, if the configuration information set in the configuration information processor 125 is included in the received configuration information list, the configuration information client 123 acquires the changed configuration information from the configuration information server 110 to be changed and set in the configuration information processor 125.

When the configuration information is changed in the microservice platform, through the configuration information change notifying step S110, the configuration information list checking step S120, and the changed configuration information applying step S130 described above, the configuration information may be synchronized in real time.

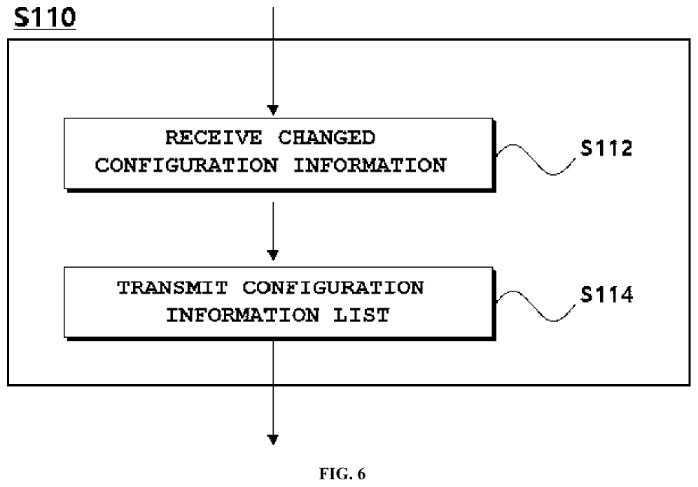

FIG. 6 is a procedure flowchart for explaining a configuration information change notifying step of FIG. 5 in detail.

Referring to FIG. 6, the configuration information change notifying step S110 is configured to include a changed configuration information receiving step S112 and a configuration information list transmitting step S114.

In the changed configuration information receiving step S112, the configuration information server 110 receives configuration information changed by the configuration information manager.

In the configuration information list transmitting step S114, the configuration information server 110 may create a configuration information list using the configuration information received in step S112. In step S114, the configuration information is configured to include a configuration information item and a configuration information content and the configuration information list includes at least one configuration information item. The configuration information server 110 transmits the created configuration information list to the configuration information client 123 to notify the change of the configuration information. In step S114, the configuration information server 110 transmits the configuration information list to the configuration information client 123 by a real-time transfer method, such as HTTP Polling, HTTP long polling, Websocket, Server-sent events or rRPC.

Through the steps S112 and S114, the configuration information server 110 receives the configuration information changed by the configuration information manager 10 to create a configuration information list and transmits the created configuration information list to the configuration information client 123 to notify the microservice module 120 of the change of the configuration information.

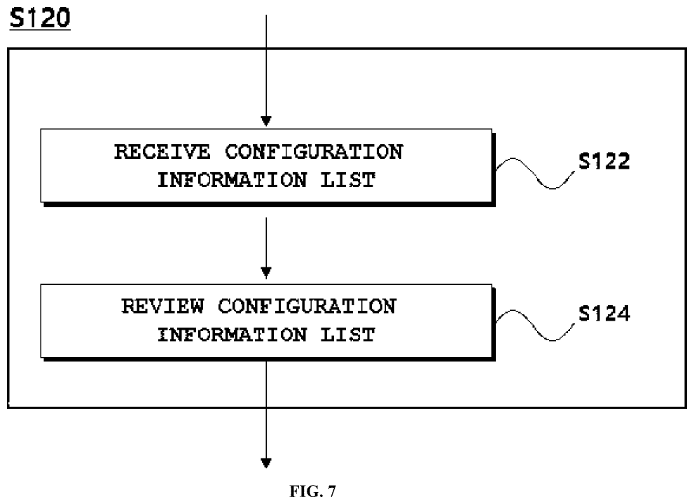

FIG. 7 is a procedure flowchart for explaining a configuration information list checking step of FIG. 5 in detail.

Referring to FIG. 7, the configuration information list checking step S120 is configured to include a configuration information list receiving step S122 and a configuration information list reviewing step S124.

In the configuration information list receiving step S122, the configuration information client 123 receives the configuration information list which is transmitted by the configuration information server 110 in step S114 of FIG. 6, in real time.

In the configuration information list reviewing step S124, the configuration information client 123 reviews the configuration information list to check whether the configuration information item set in the configuration information processor is included in the configuration information list.

Through the steps S122 and S124, if the configuration information set in the configuration information processor 125 is included in the received configuration information list, the configuration information client 123 may know that the configuration information server 110 has the changed configuration information.

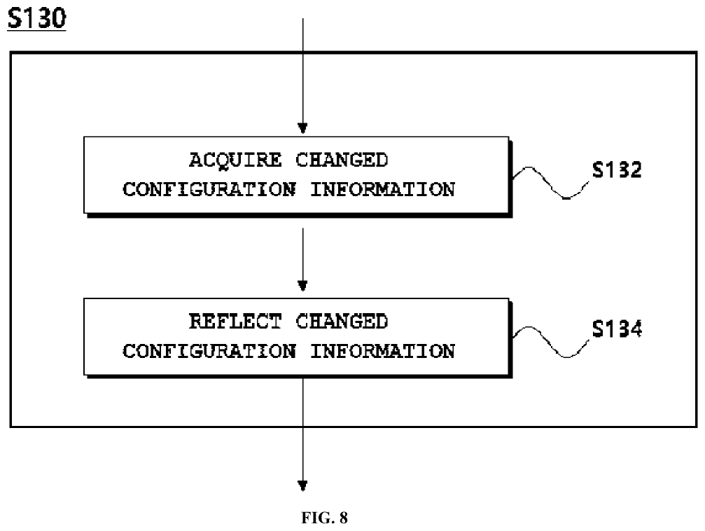

FIG. 8 is a procedure flowchart for explaining a changed configuration information applying step of FIG. 5 in detail.

Referring to FIG. 8, the changed configuration information applying step S130 is configured to include a changed configuration information acquiring step S132 and a changed configuration information reflecting step S134.

In the changed configuration information acquiring step S132, if the configuration information set in the configuration information processor 125 is included in the received configuration information list, the configuration information client 123 requests the configuration information about an item set in the configuration information processor 125 from the configuration information server 110 to acquire the changed configuration information through the configuration information client 123.

In the changed configuration information reflecting step S134, the configuration information processor 125 changes and sets the configuration information according to the configuration information acquired in step S132 to dynamically adjust the operation of the microservice according to the changed and set configuration information.

Through the steps S132 and S134, if the configuration information list set in the configuration information processor 125 is included in the configuration information list, the configuration information client 123 may apply the changed configuration information acquired from the configuration information server 110 to the microservice operation.

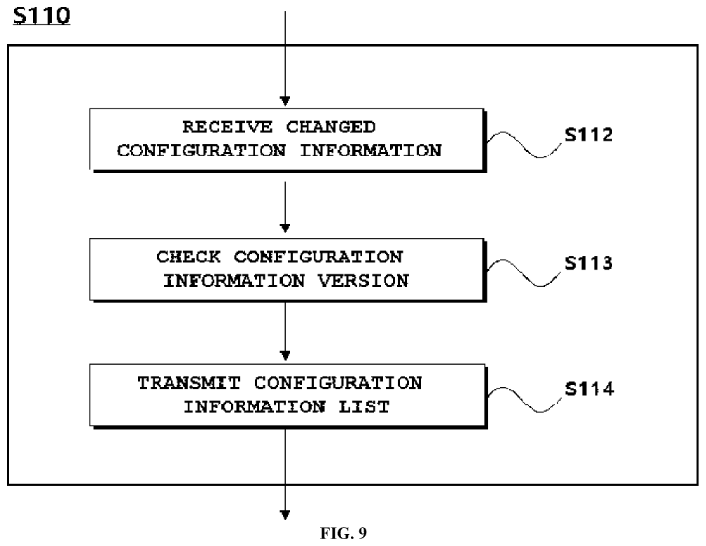

FIG. 9 is a procedure flowchart for explaining a method for synchronizing configuration information in a microservice platform according to another exemplary embodiment of the present disclosure.

Referring to FIG. 9, a configuration information change notifying step S110 of a method for synchronizing configuration information in a microservice platform according to an exemplary embodiment of the present disclosure is configured to include a changed configuration information receiving step S112, a configuration information version checking step S113, and a configuration information list transmitting step S114.

In the changed configuration information receiving step S112, the configuration information server 110 receives configuration information changed by the configuration information manager. In step S112, the configuration information server 110 manages configuration information including a configuration information version, a configuration information item, and a configuration information content.

In the configuration information version checking step S113, if there is no notification of the change of the configuration information of the configuration information server 110 for a predetermined time or periodically, the configuration information client 123 requests and receives a version of latest configuration information from the configuration information server 110. In step S113, the configuration information client 123 has a version of finally received configuration information. If the version of the configuration information server 110 does not match the current version information of the configuration information client 123, the configuration information client 123 determines that the notification of the change of the configuration information has failed to be received and requests the configuration information list from the configuration information server 110.

In the configuration information list transmitting step S114, the configuration information server 110 may create a configuration information list using the configuration information received in step S112. In step S114, the configuration information is configured to include a configuration information item and a configuration information content and the configuration information list includes at least one configuration information item. The configuration information list may be a configuration information list including changed matters between the latest version information and the current version information.

The configuration information server 110 transmits the created configuration information list to the configuration information client 123 by a real time transfer method to notify the change of the configuration information. The real time transfer method may be HTTP polling, HTTP long polling, Websocket, server-sent events, or rRPC.

Through the steps S112, 124, and 126, the configuration information client 123 receives the configuration information list from the configuration information server 110 automatically or upon the request of the configuration information client 123.

As described above, according to the present disclosure, a configuration information synchronizing method in a microservice platform and a synchronizing system which synchronize configuration information in real time by transmitting a notification of the change in the configuration information to each microservice when the configuration information is changed in the microservice platform. According to the present disclosure, a configuration information synchronizing method in a microservice platform and a synchronizing system which request notification of change in the configuration information by comparing configuration information versions when there is no notification of change in the configuration information for a predetermined period of time are provided.

A method for synchronizing configuration information in a microservice platform within a cloud computing environment and a system implementing the same are not limited to the above-described specific exemplary embodiment, but may be applied to various situations of synchronizing configuration information in a microservice platform of a cloud computing environment and all the method for synchronizing configuration information in a microservice platform within a cloud computing environment which is applied to various situations and the system implementing the same are considered to fall within the technical spirit of the present disclosure.

Preferred embodiments of the present invention have been illustrated and described above, but the present invention is not limited to the above-described specific embodiments. It is obvious that various modifications can be made by those skilled in the art, to which the present invention pertains without departing from the gist of the present invention, which is claimed in the claims, and such modifications should not be individually understood from the technical spirit or prospect of the present invention. Therefore, the scope of the present invention should not be limited to the described exemplary embodiment and not only the claims to be described below, but also all the modifications equivalent to or same as the claims shall be considered to fall within the spirit of the present disclosure.

### Explanation of Reference Numerals and Symbols

10: Configuration information manager
100: Configuration information server
120: Microservice module
123: Configuration information client
125: Configuration information processor

What is claimed is:

1. A configuration information synchronizing system in a microservice platform, comprising:
a configuration information server which creates a configuration information list when configuration information is changed to transmit the configuration information list to a configuration information client; and
a microservice module which is an object to which the changed configuration information is applied in a microservice platform and includes the configuration information client and a configuration information processor,
wherein if configuration information set in the configuration information processor is included in the configuration information list, the configuration information client acquires the changed configuration information from the configuration information server to transmit the changed configuration information to the configuration information processor.

2. The configuration information synchronizing system in a microservice platform according to claim 1, wherein the microservice module is a microservice application which performs a specific function in a microservice platform.

3. The configuration information synchronizing system in a microservice platform according to claim 1, wherein the configuration information includes a configuration information item and a configuration information content and the configuration information list includes the configuration information item.

4. The configuration information synchronizing system in a microservice platform according to claim 1, wherein the configuration information includes file information, attribute information, and version information used to run, perform, and end a microservice.

5. The configuration information synchronizing system in a microservice platform according to claim 4, wherein the file information includes a setting file required to operate the microservice and a certificate file and the attribute information includes a key-value type setting information.

6. The configuration information synchronizing system in a microservice platform according to claim 4, wherein the version information includes at least one of a version number which identifies a version state of the configuration information and a timestamp.

7. The configuration information synchronizing system in a microservice platform according to claim 1, wherein the configuration information includes a plurality of configuration information and the configuration information processor includes a plurality of configuration information processors which processes each of the plurality of configuration information.

8. The configuration information synchronizing system in a microservice platform according to claim 1, wherein the configuration information processor changes the configuration information setting according to the changed configuration information which is received from the configuration information client to adjust an operation of the microservice.

9. The configuration information synchronizing system in a microservice platform according to claim 1, wherein the configuration information server transmits the configuration information list to the configuration information client in a real time transfer method selected from HTTP polling, HTTP long polling, Websocket, Server-sent events, and rRPC.

10. The configuration information synchronizing system in a microservice platform according to claim 1, wherein the configuration information server and the configuration information client hold version information of the configuration information and the configuration information client compares version information of current configuration information of the configuration information client with version information of current configuration information of the configuration information server and if the version information do not match, requests the configuration information list from the configuration information server.

11. The configuration information synchronizing system in a microservice platform according to claim 10, wherein if the configuration information list is not received from the configuration information server for a predetermined period of time, the configuration information client requests the version information of the current configuration information of the configuration information server from the configuration information server and compares the current configuration information of the configuration information server received from the configuration information sever with version information of the current configuration information of the configuration information client.

12. A configuration information synchronizing method in a microservice platform, comprising:
a configuration information change notifying step of receiving changed configuration information to create a configuration information list and transmit the created configuration information list to a configuration information client, by a configuration information server;
a configuration information list checking step of reviewing the configuration information list to check whether configuration information set in a configuration information processor is included in the configuration information list, by the configuration information client; and
a changed configuration information applying step of acquiring the changed configuration information from the configuration information server, if configuration information set in a configuration information processor is included in the configuration information list, to change the changed configuration information to be set in the configuration information processor, by the configuration information client.

13. The configuration information synchronizing method in a microservice platform according to claim 12, wherein the configuration information change notifying step includes:
a changed configuration information receiving step of receiving configuration information changed by a configuration information manager, by the configuration information server; and
a configuration information list transmitting step of creating a configuration information list using the received configuration information and transmitting the configuration information list to the configuration information client to notify the change of the configuration information, by the configuration information server.

14. The configuration information synchronizing method in a microservice platform according to claim 13, wherein the configuration information includes a configuration information item and a configuration information content and the configuration information list includes at least one configuration information item.

15. The configuration information synchronizing method in a microservice platform according to claim 12, wherein the configuration information list checking step includes:
a configuration information list receiving step of receiving the configuration transmission—>information list from the configuration information server, by the configuration information client; and
a configuration information list reviewing step of reviewing the configuration information list and checking whether the configuration information item set in a configuration information processor is included in the configuration information list.

16. The configuration information synchronizing method in a microservice platform according to claim 15, wherein the changed configuration information applying step includes:
a configuration information acquiring step of requesting configuration information about an item set in the configuration information processor from the configuration information server if the configuration information set in the configuration information processor is included in the configuration information list, to acquire changed configuration information, by the configuration information client; and
a changed configuration information reflecting step of dynamically adjusting an operation of a microservice according to the changed and set configuration information by changing and setting the configuration information according to the acquired changed configuration information, by the configuration information processor.

17. The configuration information synchronizing method in a microservice platform according to claim 12, wherein the configuration information server manages configuration information including a configuration information version, a configuration information item, and a configuration information content and the configuration information client holds a finally received configuration information version.

18. The configuration information synchronizing method in a microservice platform according to claim 17, wherein the configuration information change notifying step includes:
a changed configuration information receiving step of receiving configuration information changed by a configuration information manager, by the configuration information server; and
a configuration information version checking step of requesting the configuration information version from the configuration information server to compare with a configuration information version of the configuration information client and requesting the configuration information list from the configuration information server if version information of the configuration information server does not match version information of the configuration information client, by the configuration information client; and
a configuration information list transmitting step of creating a configuration information list using the received configuration information and transmitting the configuration information list to the configuration information client, by the configuration information server.

19. The configuration information synchronizing method in a microservice platform according to claim 18, wherein the configuration information list is a configuration information list including a changed content between version information of the configuration information server and version information of the configuration information client.

20. The configuration information synchronizing method in a microservice platform according to claim 18, wherein the configuration information version checking step includes:
a step of requesting a version of configuration information from the configuration information sever when there is no notification of change of the configuration information of the configuration information server for a predetermined period of time or periodically.
